(19) United States
(12) Patent Application Publication
(10) Pub. No.: US 2015/0177946 A1
(43) Pub. Date: Jun. 25, 2015

(54) SYSTEM AND METHOD FOR CONTROLLING DISPLAY OF AVN

(71) Applicant: Hyundai Motor Company, Seoul (KR)

(72) Inventor: Sang Yeon LIM, Seongnam-si (KR)

(21) Appl. No.: 14/466,549

(22) Filed: Aug. 22, 2014

(30) Foreign Application Priority Data
Dec. 20, 2013 (KR) 10-2013-0160059

(51) Int. Cl. G06F 3/0488; G06F 3/0484

(52) U.S. Cl. CPC G06F 3/0488; G06F 3/0484

(57) ABSTRACT

The present invention relates to a system and a method for controlling a display of an AVN of a vehicle which sense vibrations occurring while a vehicle is driven to expand touchable UI elements, such as buttons, etc., within an AVN screen, thereby enabling a user to facilitate a touch operation. The present invention is to provide a system and a method for controlling a display of an AVN of a vehicle capable of enabling a driver to easily touch menus of a display screen without wrongly operating the touch menus by performing a control to temporarily expand touchable UI elements, such as a home button most frequently used, on the display screen of the AVN system when top and bottom and left and right vibrations of the vehicle is sensed.

### CROSS-REFERENCE TO RELATED APPLICATION

This application claims under 35 U.S.C. §119(a) the benefit of Korean Patent Application No. 10-2013-0160059 filed on Dec. 20, 2013, the entire contents of which are incorporated herein by reference.

### BACKGROUND

1. Technical Field

The present disclosure relates to a system and a method for controlling display of audio, video and navigation (AVN) of a vehicle. More particularly, the present disclosure relates to a system and a method for controlling display of an AVN of a vehicle which can sense vibrations occurring while the vehicle is driven to expand touchable user interface (UI) elements, such as buttons, etc., within an AVN screen. This enables a user to facilitate a touch operation.

2. Background Art

An audio, video, navigation (AVN) system may be mounted in a vehicle. For example a head unit, is a multimedia system in which an audio unit, a video unit, a telematics unit including a navigation, etc., are integrated into one unit. Such a head unit may allow a user to conveniently and intensively operate various types of multimedia apparatuses. Such apparatuses may efficiently use a space, such as an instrument panel and a center fascia of a vehicle.

The audio unit, the video unit, and the telematics unit including the navigation, which are all integrated into an AVN system, can be respectively operated by their respective switch buttons. Due to various functions of the switch buttons, many kinds of switch buttons can be applied on a switch operation panel.

Further, when each unit of the AVN system is operated, various menus are arranged on a display screen. The various menus are able to be touched and when the screen of the audio unit is converted to a screen of the video unit or the screen of the audio unit is converted to a screen of the telematics unit, a home button is generally touched.

When a driver's posture may be leaned to one side due to several vibration situations, such as when a vehicle is turned left and right during the driving, when a vehicle goes over a hump, when a vehicle climbs a steep slope, and the like, there is an inconvenience to the driver. As a result, the driver may not appropriately touch the touch operation menus. Thus, the touch operation menus such as the home button, and the like which are displayed on the display screen of the AVN system, may be incorrectly operated by the driver.

Therefore, since currently released vehicles use touch buttons larger than necessary to prevent the AVN touch buttons from being wrongly operated when the vehicle is vibrated, disposition freedom of the touch button for a detailed UI may be reduced and aesthetics of the UI may be degraded.

Further, according to an example of the related art, when a finger approaches the touch buttons using a proximity sensor, a technology of automatically expanding the touch buttons, and the like has been applied, in which at least four proximity sensors need to be disposed at the top and bottom and left and right of the AVN display screen.

However, since at least four proximity sensors are separately mounted, manufacturing costs may be increased. Since proximity recognition is frequently missed when the proximity sensor is wrongly operated and the finger approaches between the proximity sensors, a problem in reliability may occur. Furthermore since the driver hardly keeps a front view when the finger moves to the proximity sensor side near the AVN screen during the driving, safe driving may be interrupted.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art and provide a system and a method for controlling a display of an AVN of a vehicle capable of enabling a driver to easily touch menus of a display screen without wrongly operating the touch menus. In an aspect, this can be accomplished by performing temporarily expanding touchable UI elements (such as a frequently used home button), on the display screen of the AVN system when top, bottom, left and/or right vibrations of a vehicle are sensed.

In one aspect, the present invention provides a system for controlling a display of an AVN of a vehicle, including: a vibration sensing unit configured to sense top and bottom and left and right vibrations of the vehicle; and a display control unit configured to expand touch buttons within an AVN display screen when a vibration sensing value of the vibration sensing unit is a reference value or more.

In an exemplary embodiment, the vibration sensing unit may be adopted as an acceleration sensor which measures front and back, left and right, and top and bottom slope information of the vehicle.

In another aspect, the present invention provides a method for controlling a display of an AVN of a vehicle, including: sensing a vibration of a vehicle with a slope value of a vehicle body; and controlling a display to temporarily and automatically expand touch buttons within an AVN display screen when the sensed slope value is a reference value or more.

In an exemplary embodiment, in the controlling of the display, the touch buttons may be expanded in an opposite direction to a sensed slope direction.

In another exemplary embodiment, in the controlling of the display, the touch buttons may be expanded while undergoing a change in shape, form, and color.

In still another exemplary embodiment, in the controlling of the display, the touch buttons may be expanded in proportion to a sensed slope value.

By providing means to solve the above problems, the present invention provides the following advantages.

Firstly, even though the driver takes an unstable posture that he/she is leaned to one side when the vehicle is vibrated, the driver may easily operate the touch buttons without wrongly operating the touch buttons by performing a control to temporarily expand the touch buttons (for example, a home button, a menu button, a mode selection button, etc.) of the AVN display screen. This improves driving safety.

Secondly, it is possible to provide operation accuracy and convenience for the touch buttons when the vehicle is vibrated by expanding the size of the touch button and changing the color and shape of the touch buttons to a specific form.

Other aspects and exemplary embodiments of the invention are discussed below.

It is understood that the term “vehicle” or “vehicular” or other similar term(s) as used herein are inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that can have two or more sources of power, for example both gasoline-powered and electric-powered vehicles.

The above aspects and other features of the invention are discussed below.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a configuration diagram of a system for controlling a display of an AVN of a vehicle according to an exemplary embodiment of the present invention;

FIG. 2 is a diagram illustrating a display screen showing a method for controlling a display of an AVN of a vehicle according to an exemplary embodiment of the present invention;

FIG. 3 is a diagram illustrating a display screen showing the method for controlling a display of an AVN of a vehicle according to the another exemplary embodiment of the present invention; and

FIG. 4 is a diagram illustrating a display screen showing the method for controlling a display of an AVN of a vehicle according to still another exemplary embodiment of the present invention.

Reference numerals set forth in the Drawings includes reference to the following elements as further discussed below:

10: Vibration sensing unit

20: Display control unit

30: AVN display

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

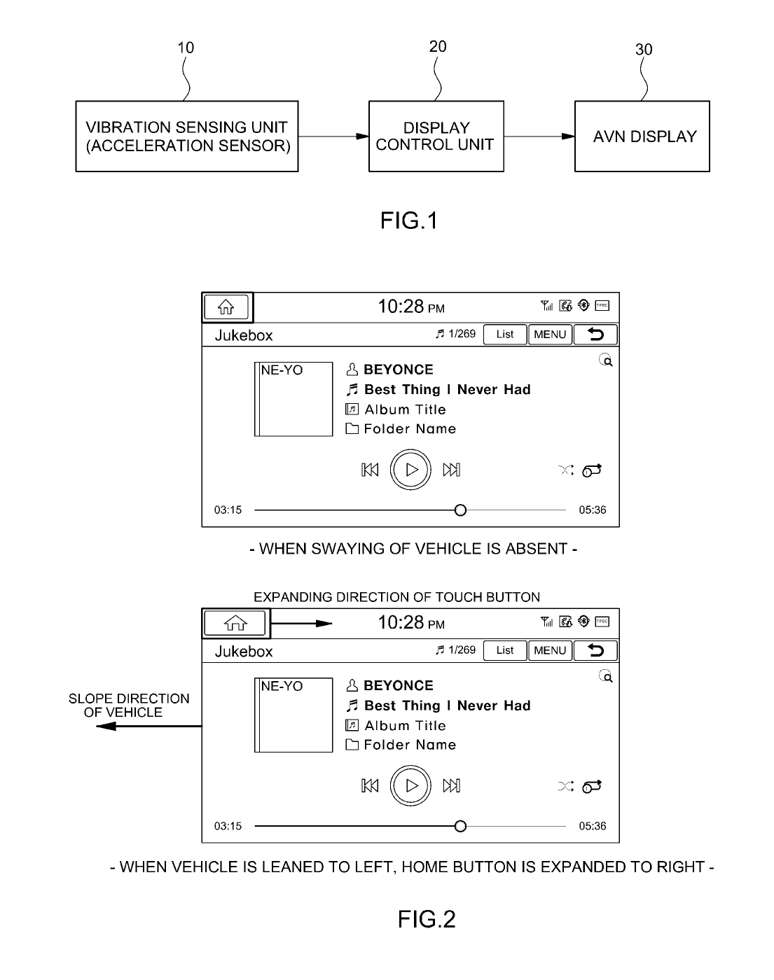

FIG. 1 is a configuration diagram of a system for controlling a display of an AVN of a vehicle according to an exemplary embodiment of the present invention.

Vibration sensing unit 10 can sense vertical and horizontal vibrations of a vehicle. The vibration sensing unit 10 can be an acceleration sensor which is used in apparatuses, such as an Electronic Stability Control (ESC) and an air bag of a vehicle. Current front and back, left and right, and top and bottom slope information of the vehicle is collected in real time by using the acceleration sensor mounted in the vehicle. Measurement information of the vibration sensing unit 10, i.e., the acceleration sensor, is transferred in real time to a display control unit 20 which controls the display for various types of touch buttons, and the like, within the AVN display 30 screen. In an exemplary embodiment, when a vibration sensing value transferred from the display control unit 20 to the vibration sensing unit 10 (that is when a slope value is a reference value or more) an operation or control to expand the touch buttons within the AVN display screen is performed.

A method for controlling a display of an AVN according to an exemplary embodiment of the present invention based on the above configuration will be described below.

First, sensing of the vibration of the vehicle with the slope value of a vehicle body is performed. That is, the current front and back, left and right, and top and bottom slope information of the vehicle is measured in real time by the acceleration sensor which can be mounted in the apparatuses (e.g., the ESC and the airbag of the vehicle) and then is transferred to the display control unit 20.

Next, when the slope value is the reference value or more, the display control unit 20 performs the display control to temporarily automatically expand the touch buttons within the AVN display screen.

In this case, the touch button is expanded in an opposite direction to the sensed slope direction. The reason is that the driver may more easily operate the touch buttons by expanding the touch buttons in a direction in which the driver is leaned since the driver is leaned to an opposite side to the slope direction at the time of the turn when driving the vehicle.

For example, as illustrated in FIG. 2, when the vehicle is leaned to the left in the state in which a music file playback screen is displayed on the display screen by operating an audio unit, the driver may easily touch a home button during the driving by performing a control to expand the displayed home button among upper menus. The menu may be expanded towards the right which is the same direction as the direction in which the driver is leaned while being an opposite direction to the slope direction of the vehicle.

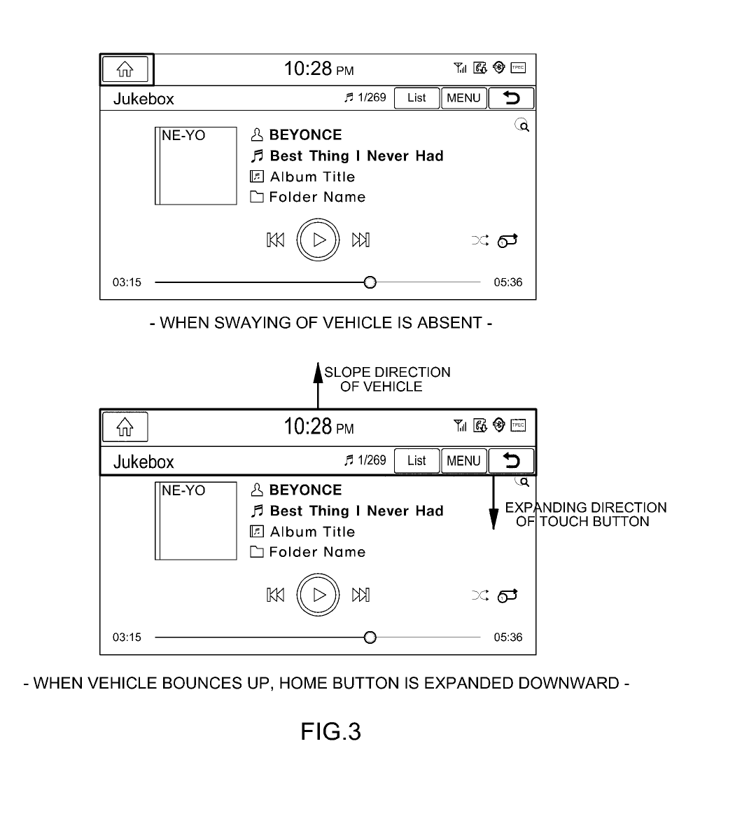

Alternatively, as illustrated in FIG. 3, when the vehicle is vibrated vertically while going over a hump the vehicle body bounces up. When the vehicle body bounces up, the driver may, during driving, easily touch the home button in the state in which the music file playback screen is displayed on the display screen by performing a control to expandably display the home button (among the upper menus) downward. Further, when the touch button is expandably displayed as described above, the touch button may be expandably displayed in proportion to the slope value sensed by the acceleration sensor.

For example, when the vehicle is smoothly turned, the leaning of the driver is small. Therefore, the expansion of the touch button is also small. When the vehicle is suddenly turned, the leaning of the driver is large and therefore the expansion of the touch button is also large. In this way, the size of the touch button may be expandably displayed in proportion to the slope value sensed by the acceleration sensor.

Meanwhile, when the UI elements within the display screen in addition to the touch buttons, and the like are arranged to be leaned to one side, the UI elements are displayed to be changed to the other position (opposite direction to the slope direction of the vehicle) within the display screen. Thus, all the UI elements within the display screen may be rearranged without being interrupted by the vibration of the vehicle.

Further, when the touch button is expandably displayed as described above, the change in specific shape, form, color, and the like is provided to the touch buttons, such that the driver may more clearly recognize the positions of the touch buttons.

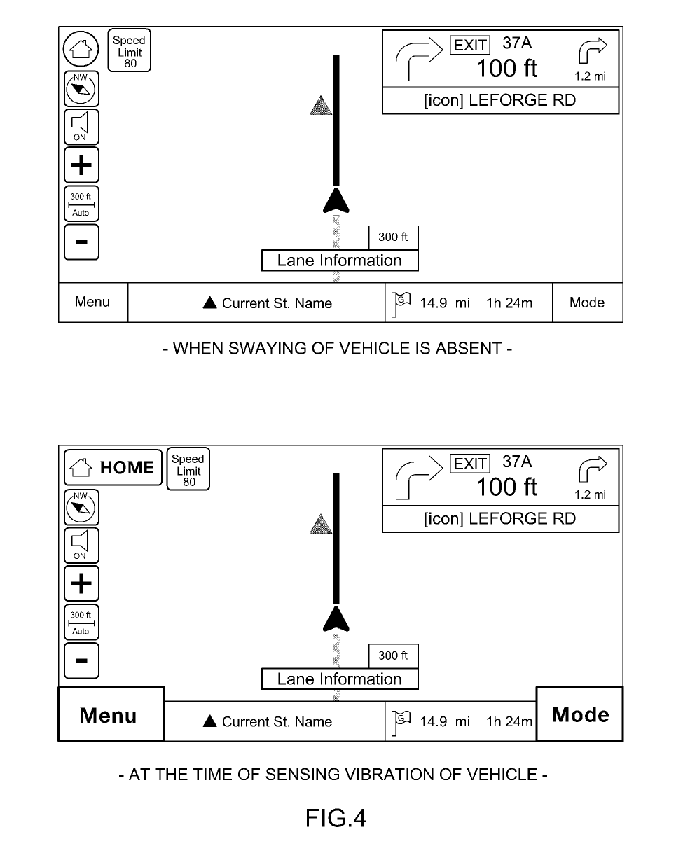

For example, as illustrated in FIG. 4, even though the vehicle is leaned in the front and back, top and bottom, left and right directions (or any combination thereof) and the driver is leaned to one side, the driver may easily touch the desired touch buttons by emphasis-displaying a main menu button and a mode button. The main menu button and the mode button can be arranged at a lower end with a blue color while changeably displaying a small circular home button arranged at an upper end to a rectangular shape. The buttons can be formed based on the state in which a map is displayed on the display screen by operating the navigation unit.

The process of controlling the display such as the expanding, shape change, color display, and the like of the touch button by the display control unit may use a method widely known to those skilled in the art.

As described above, even though the driver takes an unstable posture where he/she is leaned to one side when the vehicle is vibrated, the driver may easily operate the touch buttons without wrongly/incorrectly operating the touch buttons. The driver may easily operate the touch buttons by performing an action/control to temporarily expand the touch buttons (for example, a home button, a menu button, a mode selection button, etc.) of the AVN display screen. In this way, driving safety is enhanced.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A system for controlling a display of an AVN of a vehicle, comprising:
a vibration sensing unit configured to sense top and bottom and left and right vibrations of the vehicle; and
a display control unit configured to expand touch buttons within an AVN display screen when a vibration sensing value of the vibration sensing unit is a reference value or more.

2. The system of claim 1, wherein the vibration sensing unit is adopted as an acceleration sensor which measures front and back, left and right, and top and bottom slope information of the vehicle.

3. A method for controlling a display of an AVN of a vehicle, comprising:
sensing a vibration of a vehicle with a slope value of a vehicle body; and
controlling a display to temporarily and automatically expand touch buttons within an AVN display screen when the sensed slope value is a reference value or more.

4. The method of claim 3, wherein in the controlling of the display, the touch buttons are expanded in an opposite direction to a sensed slope direction.

5. The method of claim 3, wherein in the controlling of the display, the touch buttons are expanded while undergoing a change in shape, form, and color.

6. The method of claim 3, wherein in the controlling of the display, the touch buttons are expanded in proportion to a sensed slope value.
